(19) United States
(12) Patent Application Publication
(10) Pub. No.: US 2014/0181621 A1
(43) Pub. Date: Jun. 26, 2014

(54) METHOD OF ARRANGING DATA IN A NON-VOLATILE MEMORY AND A MEMORY CONTROL SYSTEM THEREOF

(71) Applicant: SKYMEDI CORPORATION, Hsinchu City (TW)

(72) Inventors: Ting-Wei Lin, Hsinchu City (TW); You-Chang Hsiao, Hsinchu City (TW)

(73) Assignee: SKYMEDI CORPORATION, Hsinchu City (TW)

(21) Appl. No.: 13/727,487

(22) Filed: Dec. 26, 2012

(51) Int. Cl. G06F 11/10

(52) U.S. Cl. CPC G06F 11/10; G06F 11/1008
USPC 714/773; 714/763

(57) ABSTRACT

A method of arranging data in a non-volatile memory and an associated memory control system are disclosed. A data area is divided into a plurality of valid data divisions, each having a link header followed by associated data and error correction code (ECC). At least one linking parameter is set in each said link header, and at least one obsolete data division including a bad column or columns is set, each said obsolete data division being flexible in size. Valid data divisions are linked and the obsolete data divisions are skipped, when accessing the non-volatile memory, according to the at least one linking parameter.

### BACKGROUND OF THE INVENTION

1. Field of the Invention

The present invention generally relates to a non-volatile memory, and more particularly to a method of arranging data in a non-volatile memory, and an associated memory control system.

2. Description of Related Art

A flash memory is one kind of a non-volatile solid state memory device that can be electrically erased and reprogrammed. The memory capacity of flash memories is improving at an exponential rate as predicted by Moore's law such that the flash memory is propelling into a new generation approximately every 1.5 years. The memory capacity, speed and applications are enhanced owing to improvement in process technology.

The flash memory, however, cannot be 100% flawless. A flash memory ordinarily has some defective (or bad) bits. The faulty flash memories with bad bits of a prominent amount are ordinarily thrown away, therefore greatly wasting resources.

Although some schemes have been. proposed. to use, instead. of discarding, faulty flash memories, those schemes are either inefficient or slow in accessing the flash memories.

In order to overcome the problems mentioned above, a need has thus arisen to propose a novel scheme of managing flash memories in an efficient and fast manner.

### SUMMARY OF THE INVENTION

In view of the foregoing, it is an object of the embodiment of the present invention to provide a method of arranging data in a non-volatile memory and an associated memory control system with enhanced usage efficiency and reading speed.

According to one embodiment, in a method of arranging data in a non-volatile memory, a data area is divided into a plurality of valid data divisions, each having a link header followed by associated data and error correction code (ECC). At least one linking parameter is set in each said link header; and at least one obsolete data division including a bad column or columns is set, each said obsolete data division being flexible in size. Valid data divisions are linked and the obsolete data divisions are skipped, when accessing the non-volatile memory, according to the at least one linking parameter.

According to another embodiment, a memory control system includes a non-volatile memory, a memory controller, a microcontroller unit, a volatile memory, a buffer and a first-in-first-out (FIFO). The memory controller is configured to controllably accessing the non-volatile memory; and the microcontroller unit is configured to controllably accessing the non-volatile memory. A link table with at least one linking parameter resides in the volatile memory. The buffer is disposed in a data path, between a host and the non-volatile memory, for data buffering; and the FIFO is disposed between the buffer and the non-volatile memory for flow control.

### BRIEF DESCRIPTION OF THE DRAWINGS

FIG. 1A to FIG. 1C show schematic diagrams illustrating data arrangements for accessing a non-volatile memory;

FIG. 2A to FIG. 2D show schematic diagrams illustrating data arrangements for accessing a non-volatile memory according to one embodiment of the present invention;

FIG. 3A shows an exemplary link table that stores the linking parameters;

FIG. 3B and FIG. 3C show exemplary data arrangements according to FIG. 3A;

FIG. 4 shows a memory control system adaptable to access the non-volatile memory according to the embodiment of the present invention;

FIG. 5A shows a method of writing data to the non-volatile memory in firmware aspect according to the embodiment of the present invention;

FIG. 5B shows a method of writing data to the non-volatile memory in hardware aspect according to the embodiment of the present invention;

FIG. 6A shows a method of reading data from the non-volatile memory in firmware aspect according to the embodiment of the present invention; and

FIG. 6B shows a method of reading data from the non-volatile memory in hardware aspect according to the embodiment of the present invention.

### DETAILED DESCRIPTION OF THE INVENTION

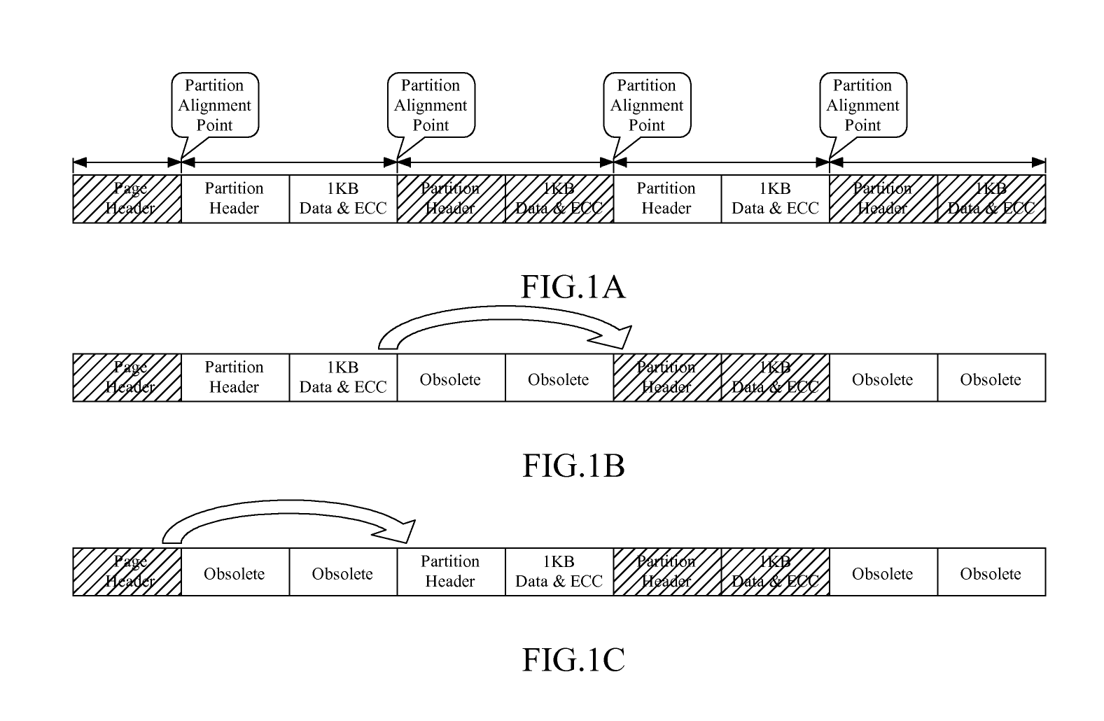

FIG. 1A shows a schematic diagram illustrating a data arrangement for accessing a non-volatile memory such as a flash memory. As shown in FIG. 1A, each page of data is divided into four partitions (or sectors), each having a partition header followed by data and an associated error correction code (ECC). The partitions in FIG. 1A have fixed positions, respectively. In other words, each partition begins at a predetermined partition alignment point as shown. In case that bad column(s) occur in the non-volatile memory, as exemplified in FIGS. 1B or 1C, a corresponding entire partition should be skipped. The positions of the skipped (or obsolete) partitions are recorded in a look-up table, according to which data are written to or read from the non-volatile memory. With respect to the data arrangement as shown in FIG. 1A, it is noted that usage efficiency of the non-volatile memory is low because entire partition need be discarded even only a small portion of that partition is defective. Further, reading speed of the non-volatile memory is low because lots of time is spent looking up the look-up table while reading data from the non-volatile memory.

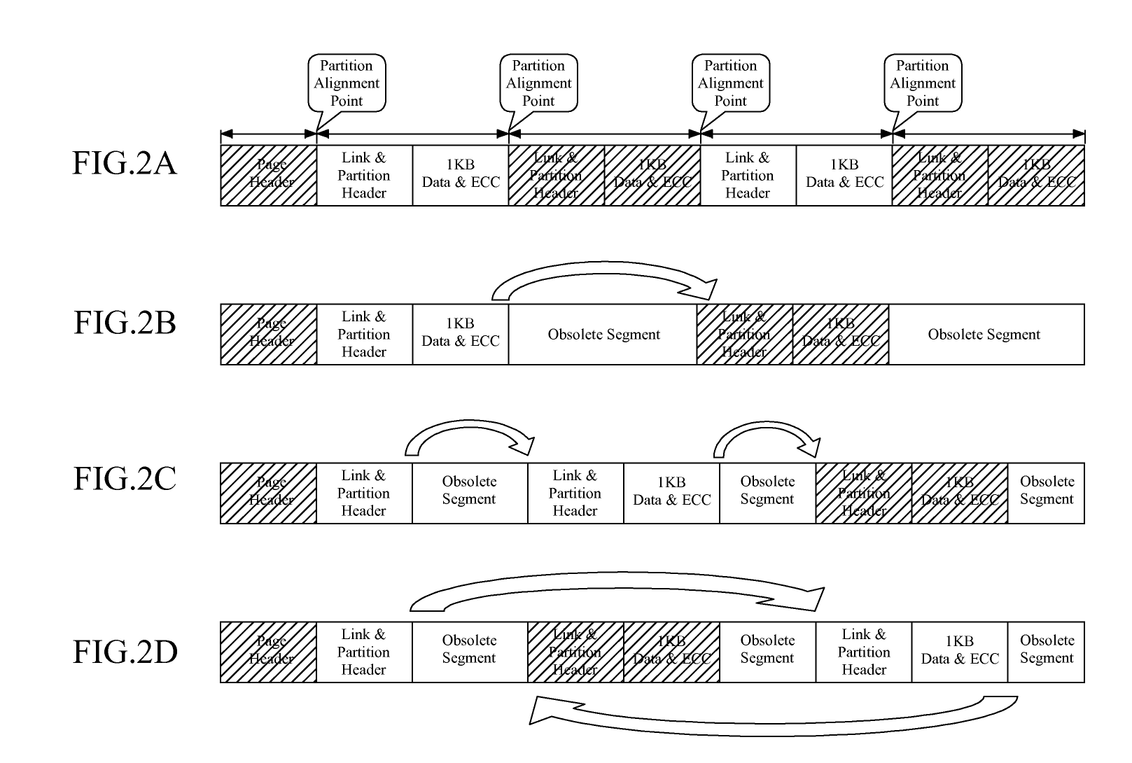

In order to overcome the disadvantages as discussed above, an embodiment of the present invention is thus disclosed. FIGS. 2A to 2D show schematic diagrams illustrating data arrangements for accessing a non-volatile memory according to one embodiment of the present invention. Although the embodiment shown in FIG. 2A to FIG. 2D adopts a partition-level scheme, in which each page is divided, into a number of partitions or sectors (say four partitions), it is appreciated that other scheme, e.g., page-level scheme, may be adopted instead. Generally speaking, a data area may be divided into a number of valid data divisions, each having a link & division header followed by associated data and ECC. In the specific embodiment, the data area may be a smallest programming unit, such as a data block, in the non-volatile memory, and the valid data division is a partition.

In case that bad column(s) occur in the non-volatile memory, as exemplified in FIGS. 2B, 2C or 2D, an obsolete segment is skipped. Compared to FIGS. 1B/1C, the obsolete segment in FIGS. 2B/2C/2D is not fixed but flexible in size, and the obsolete segment including the bad column(s) may therefore be set as small as possible. As the obsolete segment is not fixed in size, the partitions, each including a link & partition header and associated data ECC, may begin at any positions in the non-volatile memory. Accordingly, there is no partition alignment constraint as in FIGS. 1A-1C.

In the embodiment, two linking parameters are set in each link header, that is, a valid-length parameter and a pointer parameter. The valid-length parameter defines length (e.g., in partition unit) of current consecutive data, and the pointer parameter points to a column address as a beginning address of a next partition.

By way of the linking parameters, valid partitions of data may be linked, and obsolete segments may thus be skipped. When the pointer parameter is an end value or symbol instead of a column address, it indicates the end of the linked partitions.

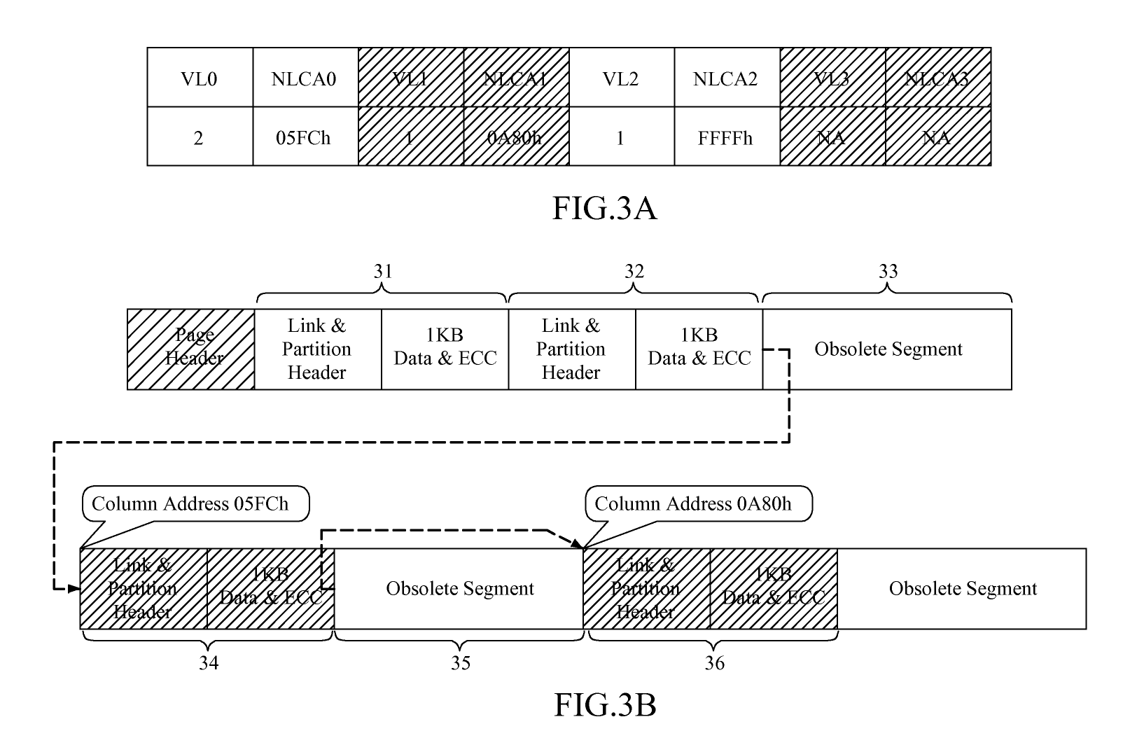

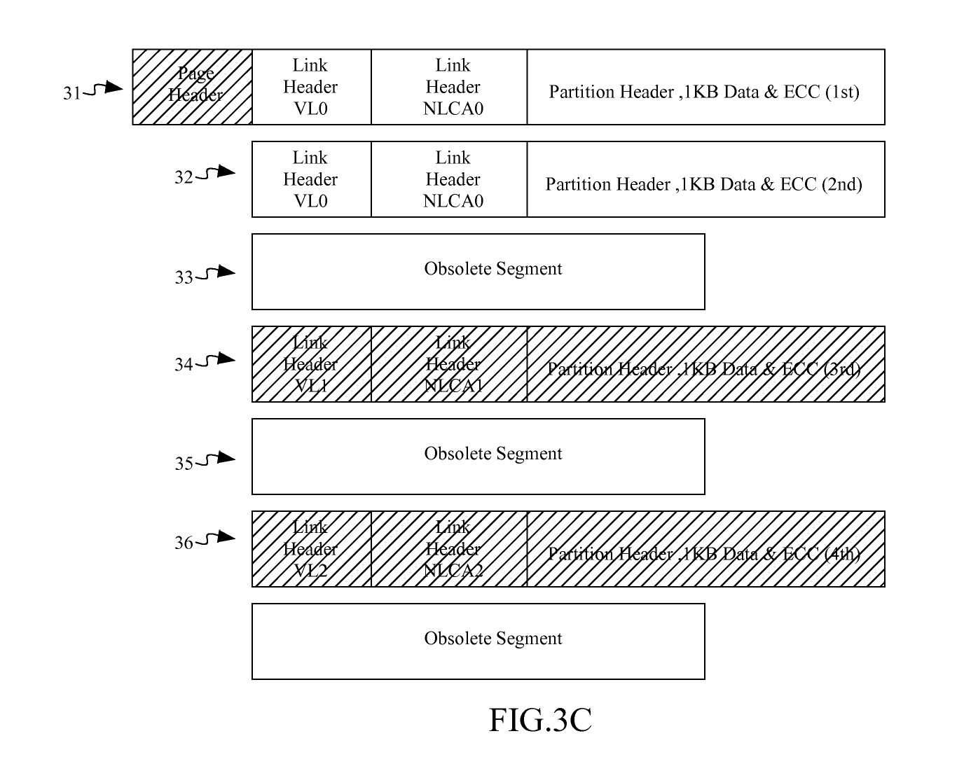

FIG. 3A shows an exemplary link table that stores the linking parameters, that is, valid-length parameters VLn and pointer parameters NLCAn (n=0, 1, 2, 3, . . . ). The link table may be prepared. and stored in the non-volatile memory, and may be retrieved and placed in a memory (e.g., SRAM). While writing data to the non-volatile memory, respective linking parameters may then be looked up from the link table and be put in respective link headers. While reading data from the non-volatile memory, partitions of valid data are accessed and obsolete segment(s) are skipped according to the linking parameters resided in the link headers. In contrast to FIGS. 1A-1C, there is no need to look up a link table while reading data from the non-volatile memory according to FIGS. 2A to 2D.

As exemplified in FIG. 3B, the first partition 31 has linking parameters VL0=2 and NLCA0=05FCh, indicating that a first partition 31 and a second partition 32 (totally two partitions) are consecutive and valid. After an obsolete segment 33, a next partition (i.e., a third partition) 34 begins at a column address 05FCh. The third partition 34 has linking parameters VL1=1 and NLCA1=0A80h, indicating that the third partition 34 (totally one partition) is valid. After an obsolete segment 35, a next partition (i.e., a fourth partition) 36 begins at a column address 0A80h. A detailed diagram of FIG. 3B is shown in FIG. 3C.

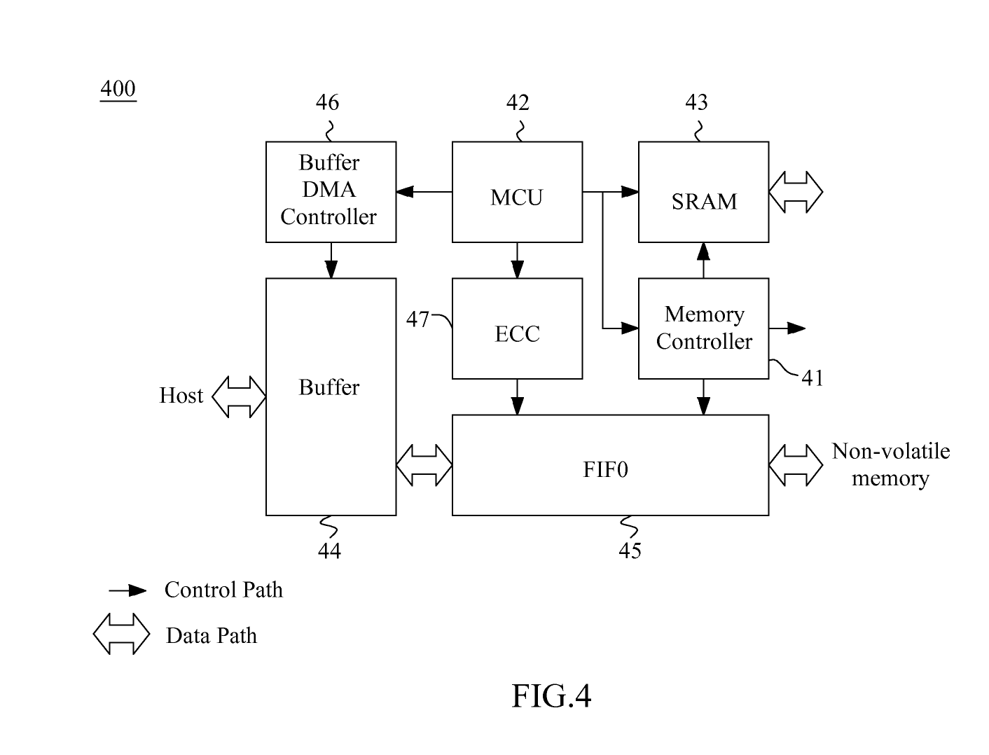

FIG. 4 shows a memory control system 400 adaptable to access the non-volatile memory according to the embodiment of the present invention. In the embodiment, the memory control system 400 includes a memory controller 41, which is primarily in charge of hardware aspect of accessing the non-volatile memory, and a microcontroller unit (MCU) 42, which is primarily in charge of firmware aspect of accessing the non-volatile memory. In addition to accessing the non-volatile memory, the MCU 42 may also be in charge of controlling the operation of the entire memory control system 400. The memory control system 400 also includes a volatile memory such as SRAM 43, in which a link table with linking parameters resides. A buffer 44 and a first-in-first-out (FIFO) 45 are disposed in a data path, between a host and the non-volatile memory, for data buffering and flow control. A buffer direct memory access (DMA) controller 46 may be used to allow certain, subsystem within the memory control system 400 to independently access the non-volatile memory. An ECC device 47 is generally utilized to enable reliable data access.

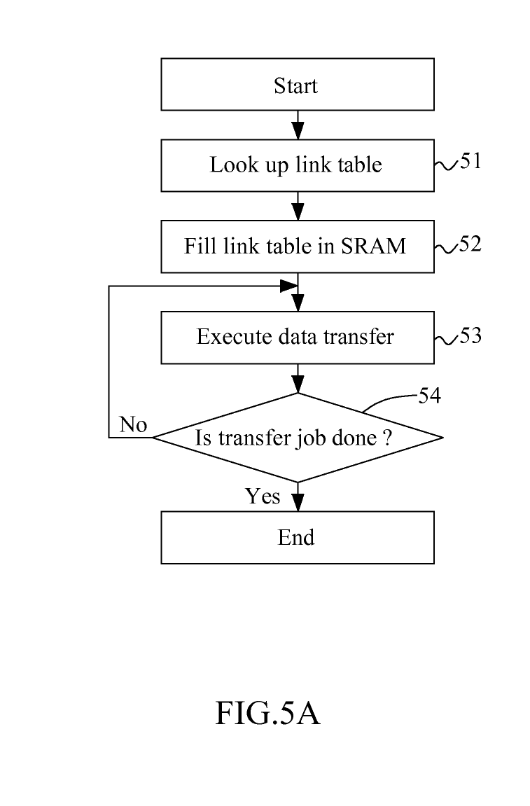

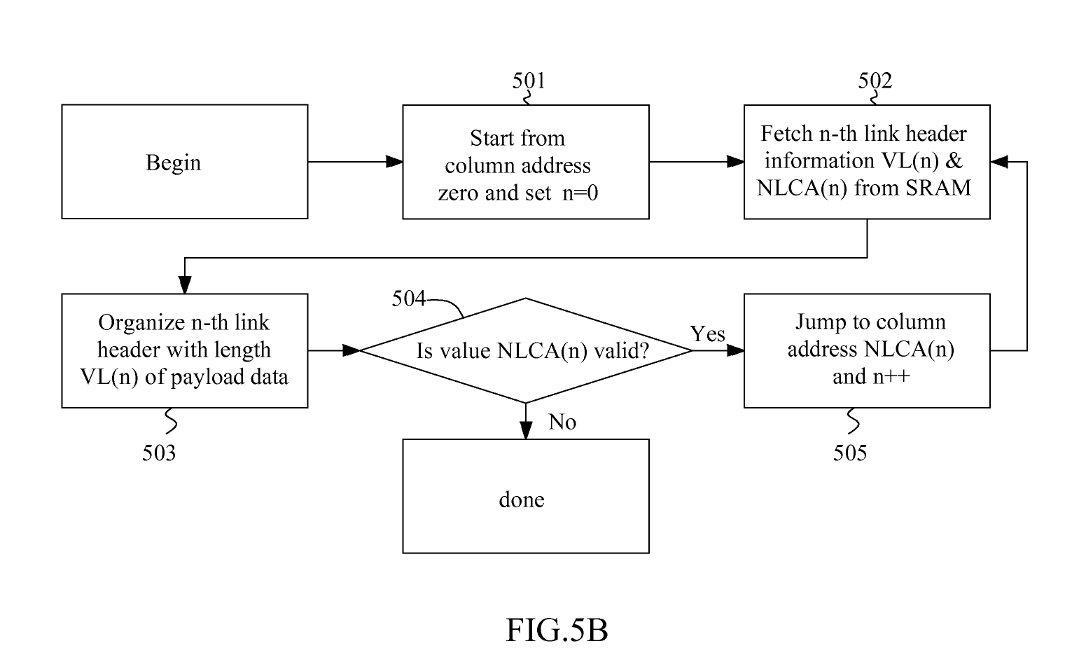

FIG. 5A shows a method of writing data to (or programming) the non-volatile memory in firmware aspect according to the embodiment of the present invention. In step 51, the MCU 42 look up a link table that, for example, is stored in the non-volatile memory. In step 52, a suitable link table is then filled in the SRAM 43. Subsequently, in step 53, data transfer from the FIFO 45 to the non-volatile memory is executed. The data transfer continues until a transfer job is done (step 54).

FIG. 5B shows a method of writing data to (or programming) the non-volatile memory in hardware aspect according to the embodiment of the present invention. In step 501, the flow starts from column address zero. In step 502, the linking parameters VL(n) and NLCA(n) of the link header are fetched from the SRAM 43. In step 503, the link header and associated (payload) data with size of VL(n) are arranged (or organized). Subsequently, if the pointer parameter NLCA(n) is determined valid in step 504, jump to a column address NLCA(n) (step 505) and the flow goes back to step 502 for programming next consecutive partition(s).

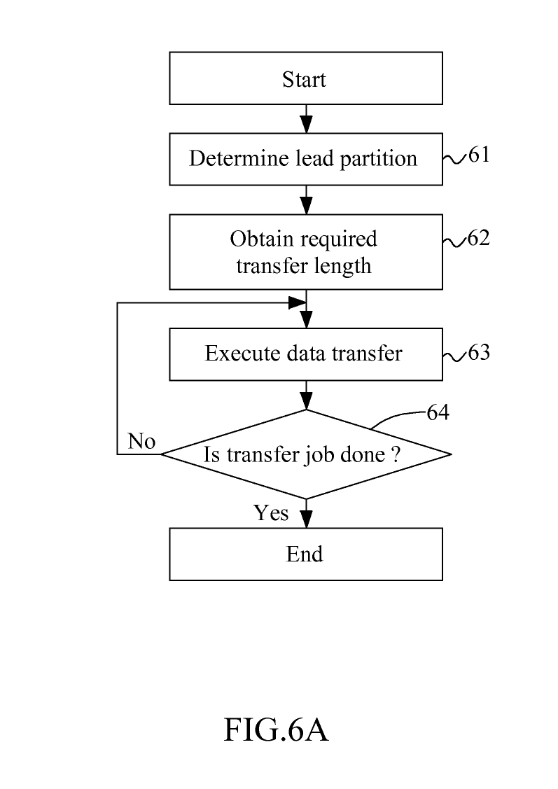

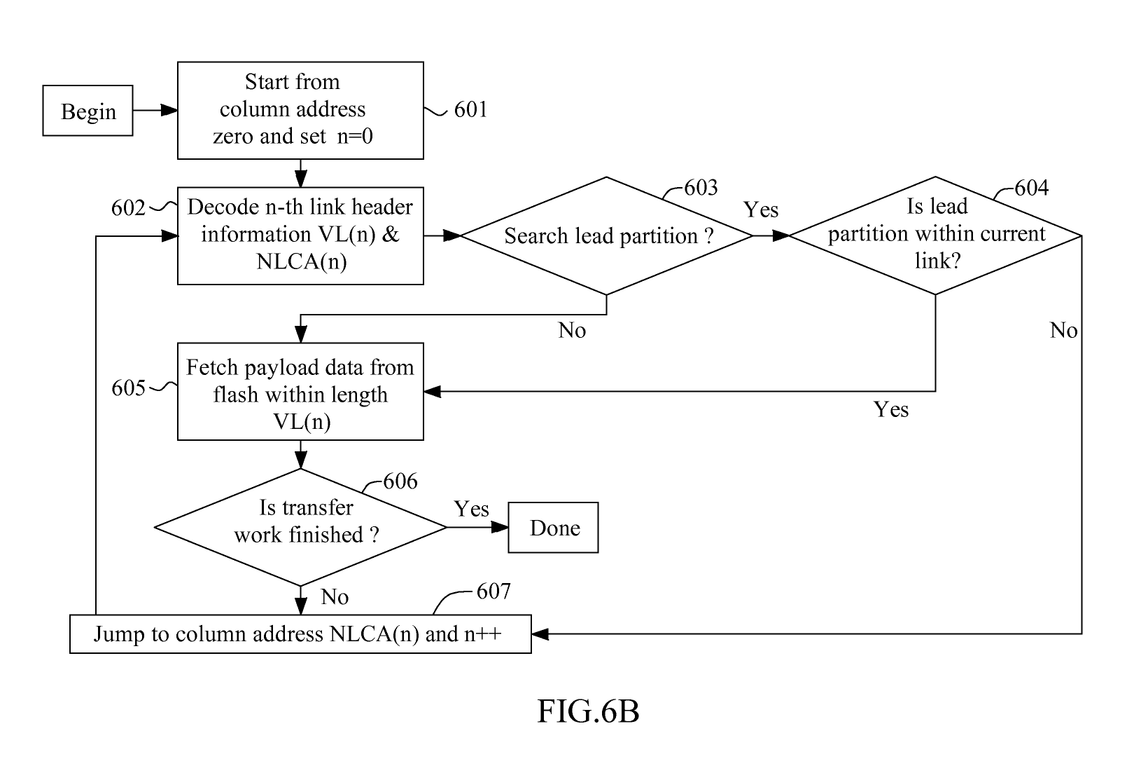

FIG. 6A shows a method of reading data from the non-volatile memory in firmware aspect according to the embodiment of the present invention. In step 61, a lead partition is determined, when necessary. In step 62, required transfer length is obtained. Subsequently, in step 63, data transfer from the non-volatile memory to the FIFO 45 is executed. The data transfer continues until a transfer job is done (step 64).

FIG. 6B shows a method of reading data from the non-volatile memory in hardware aspect according to the embodiment of the present invention. In step 601, the flow starts from column address zero. In step 602, the link header is decoded to obtain linking parameters VL(n) and NLCA(n). At the beginning of the transfer, a lead partition need be searched (step 603), and the flow goes to step 604. For the remaining transfer, there is no need of searching the lead partition, and the flow goes to step 605. In the case that the lead partition has been searched in step 603 at the beginning of the transfer, it is then determined, in step 604, whether the lead partition is within the current link. If the lead partition is determined to be within the current link, the flow goes to step 605; otherwise, the flow goes to step 607.

For example, referring to FIG. 3C, it is supposed that the lead partition is the partition 32, and the current partitions are partitions 31 and 32. Accordingly, the lead partition 32 is therefore determined to be within the current link in step 604. In another example, if the lead partition 32 is not within the current link as determined in step 604, the flow goes to step 607 to jump to a column address NLCA (step 607).

Subsequently, in step 605, data with length of VL(n) are fetched from the non-volatile (e.g., flash memory). If the transfer job has not finished (step 606), jump to a column address NLCA(n) (step 607) and the flow goes back to step 602 for accessing next consecutive partition(s).

According to the embodiment described above, only link header need be read and decoded to find out which partition start address and length are matched to our desired lead partition, instead of loading look-up table from the non-volatile memory first and then searching the address of lead partition as in a conventional system and method. Therefore, only a small SRAM is required to store the look-up table, and the data format could be versatile as well as greatly utilize the usable memory volume.

Although specific embodiments have been illustrated and described, it will be appreciated by those skilled in the art that various modifications may be made without departing from the scope of the present invention, which is intended to be limited solely by the appended claims.

What is claimed is:

1. A method of arranging data in a non-volatile memory, comprising:
dividing a data area into a plurality of valid data divisions, each having a link header followed by associated data and error correction code (ECC);
setting at least one linking parameter in each said link header;
setting at least one obsolete data division including a bad column or columns, each said obsolete data division being flexible in size; and
linking valid data divisions and skipping the obsolete data divisions, when accessing the non-volatile memory, according to the at least one linking parameter.

2. The method of claim 1, wherein the non-volatile memory is a flash memory.

3. The method of claim 1, wherein the data area is a smallest programming unit in the non-volatile memory, and the valid data division is a partition.

4. The method of claim 1, wherein the at least one linking parameter comprises:
a valid-length parameter defining length of consecutive data of a current data division or consecutive data divisions including the current data division; and
a pointer parameter pointing to a column address as a beginning address of a next valid, data division.

5. The method of claim 1, further comprising:
storing a link table containing the at least one linking parameter in the non-volatile memory;
retrieving the link table;
looking up the at least one linking parameter of the link table and putting the at least one linking parameter in the link headers respectively while writing data to the non-volatile memory; and
reading data of the valid data divisions and skipping the obsolete data divisions according to the at least one linking parameter while reading data from the non-volatile memory.

6. A memory control system, comprising:
a non-volatile memory;
a memory controller configured to controllably accessing the non-volatile memory;
a microcontroller unit configured to controllably accessing the non-volatile memory;
a volatile memory in which a link table with at least one linking parameter resides;
a buffer disposed in a data path, between a host and the non-volatile memory, for data buffering; and
a first-in-first-out (FIFO) disposed between the buffer and the non-volatile memory for flow control;
wherein a data area of the non-volatile memory is divided into a plurality of valid, data divisions, each having a link header followed, by associated data and error correction code (ECC), the at least one linking parameter being set in each said link header; and
wherein at least one obsolete data division including a bad column or columns is set, each said obsolete data division being flexible in size, therefore valid data divisions are linked and the obsolete data divisions are skipped, when accessing the non-volatile memory, according to the at least one linking parameter.

7. The system of claim 6, wherein the non-volatile memory is a flash memory.

8. The system of claim 6, wherein the data area is a smallest programming unit in the non-volatile memory, and the valid data division is a partition.

9. The system of claim 6, wherein the at least one linking parameter comprises:
a valid-length parameter defining length of consecutive data of a current data division or consecutive data divisions including the current data division; and
a pointer parameter pointing to a column address as a beginning address of a next valid data division.

10. The system of claim 6, wherein the microcontroller performs the following steps to program the non-volatile memory:
looking up the link table;
filling the link table in the volatile memory; and transferring data from the FIFO to the non-volatile memory.

11. The system of claim 10, wherein the memory controller performs the following steps to program the non-volatile memory:
fetching the at least one linking parameter from the volatile memory;
arranging the link header and associated data with size defined, by the valid-length parameter; and
jumping to the column address pointed, by the pointer parameter.

12. The system of claim 6, wherein the microcontroller performs the following steps to read data from the non-volatile memory:
determining a lead data division;
obtaining required. transfer length; and
transferring the data from the non-volatile memory to the FIFO according to the transfer length.

13. The system of claim 9, wherein the memory controller performs the following steps to read data from the non-volatile memory;
decoding the link header to obtain the at least one linking parameter;
searching a lead data division and then determining whether the lead partition is within the current data division;
fetching data with length defined, by the valid-length parameter from the non-volatile memory; and
jumping to the column address pointed, by the pointer parameter.

14. The system of claim 6, further comprising an ECC device configured to enable reliable data access of the non-volatile memory.
